(19) United States
(12) Patent Application Publication
(10) Pub. No.: US 2022/0408539 A1
(43) Pub. Date: Dec. 22, 2022

(54) CONVERGENT CONSUMABLE FOR FOCUSING PLASMA ARC

(71) Applicant: The ESAB Group Inc., Florence, SC (US)

(72) Inventor: Jacob Charles Farnham, Etna, NH (US)

(21) Appl. No.: 17/354,319

(22) Filed: Jun. 22, 2021

(51) Int. Cl. H05H 1/34; B23K 10/02

(52) U.S. Cl. CPC H05H 1/3405; B23K 10/02; H05H 1/3457; H05H 1/3452

(57) ABSTRACT

A consumable for a torch head is disclosed. The consumable for a torch head includes a frustoconical operative end, and a concave outer surface formed on the frustoconical operative end. The concave outer surface is configured to guide a flow of gas to a focal point downstream of the frustoconical operative end.

### FIELD OF INVENTION

The present invention relates to the field of plasma arc torches and, in particular, plasma torch consumables configured to create a convergent flow of gas to focus a plasma arc.

### BACKGROUND

Welding and cutting systems, such as plasma cutting systems, typically include a torch with components such as electrodes and nozzles that are consumed during a plasma cutting process. In typical plasma cutting systems, the electrode conducts current to generate a plasma arc, and the nozzle guides a flow of gas to push the plasma arc towards a workpiece and/or to constrain the plasma arc. Heat from the plasma arc may cause these consumables (e.g., electrodes and nozzles) to wear. To reduce the amount of wear, a system may limit the amount of time a plasma cutter or welder is operational (i.e., set a duty cycle). That is, the amount of time of continuous use of a torch or time between uses of the torch may be limited to prevent excess wear of the consumable. Further, initiating, or sparking, an arc between an electrode and nozzle may wear the nozzle. That is, the nozzle may be limited to a certain number of initiations before it is worn. Worn consumables are eventually replaced with new consumables. Replacing consumables reduces efficiency of a cutting or welding operation and increases a cost of the operation.

In view of at least the aforementioned issues, consumables that generate less heat and have a longer duty cycle may be desirable.

### SUMMARY

The present invention relates to a consumable having a concave surface configured to generate a convergent flow of fluid that constrains a plasma arc and/or a torch head including such a consumable. In accordance with at least one embodiment, a consumable for a torch head includes a frustoconical operative end, and a concave outer surface formed on the frustoconical operative end. The concave outer surface is configured to guide a flow of gas to a focal point downstream of the frustoconical operative end.

In accordance with at least another embodiment, a method includes guiding a flow of gas to a torch head, and directing the flow of gas along an outer concave surface formed on a distal portion of a consumable. The outer concave surface directs the flow of gas to a focal point downstream of a distal end of the consumable.

In accordance with yet another embodiment, a torch includes a gas channel, and a consumable having a frustoconical distal portion. The frustoconical distal portion includes a concave outer surface configured to guide a flow of gas from the gas channel to a focal point downstream of frustoconical distal portion.

### BRIEF DESCRIPTION OF THE DRAWINGS

To complete the description and in order to provide for a better understanding of the present invention, a set of drawings is provided. The drawings form an integral part of the description and illustrate an embodiment of the present invention, which should not be interpreted as restricting the scope of the invention, but just as an example of how the invention can be carried out. The drawings comprise the following figures:

FIG. 1 is a perspective view of a cutting system including a gas supply, a power source, cable hose, and a torch assembly configured to receive a consumable formed in accordance with an example embodiment of the present disclosure.

FIG. 2 is a cross-sectional view of a torch head according to an example embodiment.

FIG. 3 is a cross-sectional view of the torch head of FIG. 2 illustrating flows of gas moving through the torch head.

FIG. 4 is a cross-sectional view of a torch head according to another example embodiment.

FIG. 5 is a cross-sectional view of the torch head of FIG. 4 illustrating flows of gas moving through the torch head.

FIG. 6 is a block diagram of a method of directing a flow of gas in a torch according to an example embodiment.

### DETAILED DESCRIPTION

The following description is not to be taken in a limiting sense but is given solely for the purpose of describing the broad principles of the invention. Embodiments of the invention will be described by way of example, with reference to the above-mentioned drawings showing elements and results according to the present invention.

Generally, the present application is directed to generating a convergent flow of gas to focus a plasma arc. This is achieved by, including or defining a concave surface on an outer surface of a distal portion or operative end of a consumable. The concave surface guides a high-pressure boundary layer flow of gas to converge at a focal point downstream of the torch head. For example, the outer surface may have a concave shape having a parabolic slope. The high-pressure boundary layer of gas focuses a plasma arc to a fine point at the focal point, thus improving cutting or welding performance as compared to conventional torches. In at least some embodiments, the high-pressure boundary layer is created by a laminar flow of the gas.

Moreover, with the consumable presented herein, a plasma arc may be focused at a specific distance from the consumables, which may encourage precise cutting while reducing the amount of heat absorbed by consumables in the torch head. The reduced heat absorption may result in less wear of the consumables as compared to conventional torches. Additionally, since the consumables absorb less heat, the consumables may not need to dissipate as much heat as consumables in conventional torches. This may allow the consumables to be formed without cooling-specific features, such as internal cavities or coolant flow passages, that are often difficult and/or expensive to manufacture. Additionally or alternatively, this may reduce (or eliminate) the need to run coolant (gas or liquid) through the consumable during processing operations, creating savings in operational and/or commodity costs. Generally, the embodiments presented herein are discussed with reference to a plasma cutting torch; however, the embodiments can also be applied to welding torches.

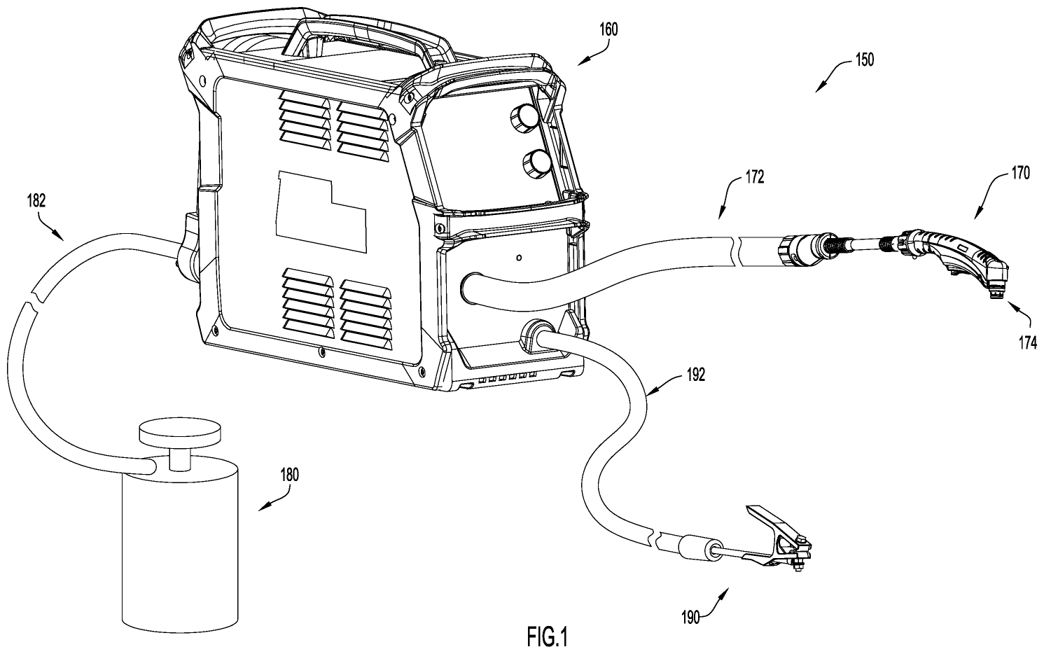

FIG. 1 illustrates an example embodiment of cutting system 150 that may utilize one or more consumables presented herein. At a high-level, the depicted cutting system 150 includes a power source 160 that supplies power to a torch assembly 170 having a torch head 174 with one or more consumables. The power source 160 also controls the flow of gas from a gas supply 180 to the torch assembly 170 (however, in other embodiments, the power source 160 might supply the gas itself). The gas supply 180 is connected to the power source via cable hose 182 and the power source 160 is connected to the torch assembly 170 via cable hose 172. The cutting system 150 also includes a working lead 192 with a grounding clamp 190. As is illustrated, cable hose 172, cable hose 182, and/or working lead 192 may each be any length. In order to connect the aforementioned components, the opposing ends of cable hose 172, cable hose 182, and/or working lead 192 may each be coupled to the power source 160, torch assembly 170, gas supply 180, or clamp 190 in any manner now known or developed hereafter (e.g., a releasable connection).

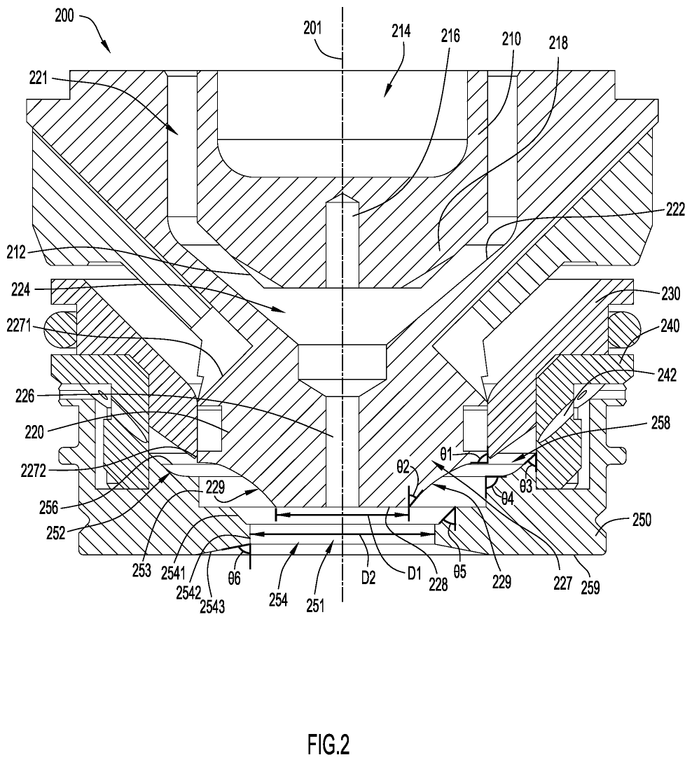

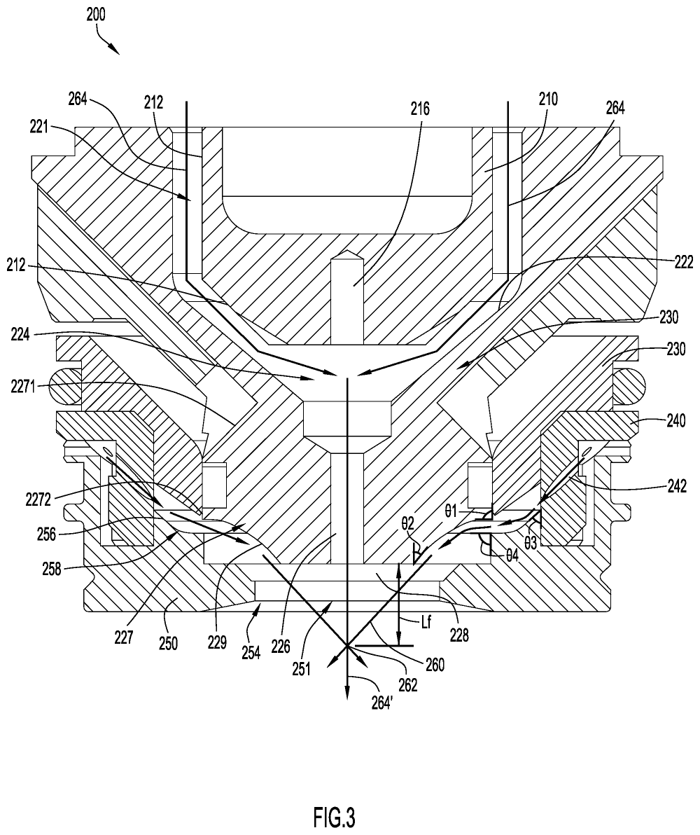

FIGS. 2 and 3 illustrate an example embodiment of a torch head 200. The torch head 200 may be disposed in torch assembly 170; however, embodiments are not limited thereto. The torch head 200 includes an electrode 210, a nozzle 220, an insulator 230, distributor 240, and a shield cup 250 disposed along a longitudinal axis 201 of the torch head 200. The electrode 210, nozzle 220, insulator 230, distributor 240, and shield cup 250 are coaxial and/or concentric. The nozzle 220 is disposed between the electrode 210 and the insulator 230. The insulator 230 is disposed between the nozzle 220 and the distributor 240. The distributor 240 is disposed between the insulator 230 and the shield cup 250. The shield cup 250 is disposed around a portion of the distributor 240.

The electrode 210 includes an outer surface 212, an electrode cavity 214 for receiving a cooling fluid, and an emissive insert 216. However, in some implementations, the electrode may not include a cavity 214 for receiving a cooling fluid. The nozzle 220 includes a nozzle cavity 221 defined by a nozzle interior surface 222. The nozzle cavity 221 is sized to receive the electrode 210 in a spaced relationship from the interior surface 222 of the nozzle 220. Thus, the nozzle interior surface 222 and the outer surface 212 of a distal portion 218 of the electrode 210 can define a plasma chamber 224 in a gap between the interior surface 222 of the nozzle 220 and the outer surface 212 of the electrode 210. A nozzle orifice 226 is fluidly coupled to the plasma chamber 224 and extends through a distal portion 227 (also referred to herein as operative end 227) of the nozzle 220.

The distal portion 227 has an outer surface 229 that is generally frustoconical, insofar as the outer surface tapers towards its bottom or distal end 228. However, the outer surface 229 need not be the only outer (e.g., side) surface of the distal portion 227. In fact, in the depicted embodiment, the distal portion 227 has three outer surfaces: a first surface 2271 that extends radially outwards and downwards towards the distal end 228; a second surface 2272 that is substantially flat except for a mating feature defined therein, and outer surface 229, which tapers radially inwards from the second surface 2272. Regardless of the overall shape and size of the distal portion 227, the outer surface 229 is concave or includes a concave portion. For example, in the depicted embodiment, the outer surface 229 of the distal portion 227 of the nozzle 220 has a parabolic slope. Put another way, a diameter, and/or a radius, of the outer surface 229 decreases towards the distal end 228, terminating at a final diameter D1 and, in some implementations, the decrease in the radius may be exponential (i.e., the radius/diameter decays exponentially to the final diameter D1).

As a more specific example, in the depicted embodiment, the distal portion 227 of the nozzle 220 has an initial angle θ1 that is about 90 degrees with respect to the longitudinal axis 201 and transitions to an ending angle θ2, at the distal end 228, of about 30 degrees with respect to the longitudinal axis 201. However, these angles are only examples and angle θ1 and angle θ2 may vary across different embodiments. For example, angle θ1 may be any angle within a range of approximately 90 degrees and approximately 120 with respect to the longitudinal axis 201, a range of approximately 100 degrees and approximately 110 degrees with respect to the longitudinal axis 201, or any other suitable range, for example, to create a smooth transition between a gas passage leading to the nozzle 220 and the outer surface 229. Meanwhile the ending angle θ2 may be any angle within a range of approximately 10 degrees and approximately 45 degrees with respect to the longitudinal axis 201, a range of approximately 5 degrees and approximately 60 degrees with respect to the longitudinal axis 201 or any other suitable range that allows control the focal point of a gas exiting the outer surface 229, as is described in detail below.

During operation, a process gas 264 is supplied to the nozzle cavity 221 and flows between the outer surface 212 of the electrode 210 and the nozzle interior surface 222 to the plasma chamber 224. In at least some embodiments, a pilot arc generated between the electrode 210 and the nozzle 220 is pushed into and/or through the plasma chamber 224 by the flow of the process gas 264. The arc superheats and ionizes the process gas 264 into a plasma arc 264′ that exits the plasma chamber 224 through the nozzle orifice 226.

The shield cup 250 includes a through hole 251 extending in a direction parallel to the longitudinal axis 201. The through hole 251 includes a shield cup inlet 252, a shield cup outlet 254 having an outlet diameter D2, and through hole sidewall 253 defining a passage between the shield cup inlet 252 and shield cup outlet 256. In the depicted embodiment, the distal portion 227 of the nozzle 220 extends through the shield cup inlet 252 into the through hole 251. However, in other embodiments, the distal portion 227 need not extend into the through hole 251 and, instead, may be aligned with but longitudinally offset from through hole 251.

The shield cup inlet 252 is defined by an inlet inner surface 256 that has a concave shape, such as a parabolically sloped concave shape. Put another way, a diameter and/or a radius of the shield cup inlet 252 decreases as towards the shield cup outlet 254. In some implementations, the decrease in the radius may be exponential. For example, in the depicted embodiment, the inlet inner surface 256 may have an initial slope θ3 of about 30 degrees and curves to an ending slope θ4 of about 90 degrees with respect to the longitudinal axis 201. That is, the inlet inner surface 256 initially slopes towards the shield cup outlet 254 at angle of 30 degrees with respect to the longitudinal axis 201 and transitions to substantially horizontal slope (e.g., 90 degrees with respect to the longitudinal axis 201). However, these angles are only examples and angle θ3 and angle θ4 may vary across different embodiments. For example, angle θ3 may be any angle within a range of approximately 0 degrees and approximately 70 degrees with respect to the longitudinal axis 201, a range of approximately 15 degrees and approximately 45 degrees with respect to the longitudinal axis 201, or any other suitable range, for example, to guide a flow of gas through the shield cup inlet 252. Meanwhile the ending angle θ4 may be any angle within a range of approximately 80 degrees and approximately 110 degrees with respect to the longitudinal axis 201, a range of approximately 70 degrees and approximately 120 degrees with respect to the longitudinal axis 201 or any other suitable range to guide a flow of gas towards the nozzle 220 and outer surface 229.

The through hole sidewall 253 extends from the inlet 252 to the outlet 254 of the shield cup 250. The through hole sidewall 253 is shown as having a stepped or L-shaped cross-section. However, in other embodiments, the through hole sidewall 253 may have a convex cross-section that conforms to the parabolic slope of the outer surface 229 of the distal portion 227. Said another way, the through hole sidewall 253 may be defined by a surface offset from the outer surface 229 of the distal portion 227 with a substantially similar, or the same, parabolic slope as the outer surface 229. In yet another embodiment, the sidewall 253 may extend from the inlet 252 to the outlet 254 with a constant slope. That is, the sidewall 253 may taper downward and radially inward towards the outlet 254 at a constant angle with respect to the longitudinal axis 201.

The outlet 254 is defined by three surfaces: a first surface 2541, a second surface 2542 and a third surface 2543. The first surface 2541 extends downward and radially inward at a constant angle from the through hole sidewall 253 to the second surface 2542. That is, the first surface 2541 defines a taper from the through hole sidewall 253 to the second surface 2542. The taper reduces the cross-section of the outlet 254 towards a distal end 259 of the shield cup 250. In some implementations, the surface may have a slope θ5 of about 45 degrees with respect to the longitudinal axis 201. However, this angle is only an example and angle θ5 may vary across different embodiments. For example, angle θ5 may be any angle within a range of approximately 15 degrees and approximately 70 degrees with respect to the longitudinal axis 201, a range of approximately 20 degrees and approximately 60 degrees with respect to the longitudinal axis 201, or any other suitable range, for example, to guide a flow of gas through the shield cup outlet 254.

The second surface 2542 extends, in parallel with the longitudinal axis 201, from the first surface 2541 to the third surface 2543. The second surface 2542 defines a throat section of the outlet 254 with the outlet diameter D2.

The third surface 2543 extends downward and radially outward towards the shield cup distal end 259. That is, a diameter or radius of the outlet 254 increases as the third surface 2543 extends towards the distal end 259. In the depicted embodiment, the third surface 2543 may have a slope θ6 of about 70 degrees with respect to the longitudinal axis 201. However, this angle is only an example and angle θ6 may vary across different embodiments. For example, angle θ6 may be any angle within a range of approximately 45 degrees and approximately 85 degrees with respect to the longitudinal axis 201, a range of approximately 75 degrees and approximately 60 degrees with respect to the longitudinal axis 201, or any other suitable range, for example, to guide a flow of gas through the shield cup outlet 254. Additionally, the angles θ5 and 06, and outlet diameter D1 may be set at any suitable range to create a Venturi effect within a flow of gas passing through the outlet 254.

Still referring to FIGS. 2 and 3, an annular or radial gap 258 extends radially between the nozzle 220 and the shield cup 250. That is, the distal portion 227 of the nozzle 220, the insulator 230, the distributor 240, and shield cup 250 define the radial gap 258 for guiding a flow of shield gas 260 from fluid or gas channels 242 of the distributor 240 to the through hole 251. Shield gas 260 exiting the radial gap 258 flows through the through hole 251 to the shield cup outlet 254. However, due to the concave surfaces of the nozzle and shield, shield gas 260 flowing from the fluid channels 242 of the distributor 240 through the radial gap 258 converges towards a focal point 262 as it exits the shield cup outlet 254.

In some implementations, the nozzle distal portion 227 and shield cup through hole 251 cooperate to create a laminar flow of shield gas 260 having a high-pressure boundary layer. For example, in the depicted embodiment, once the shield gas flow 260 can exit the fluid channels 242 of the distributor 240 and enters the radial gap 258, the inlet inner surface 256 of the shield cup 250 creates a smooth path towards the outer surface 229 of the nozzle 220. Then, the outer surface 229 gently guides the shield gas flow 260 radially inwards while also guiding the gas flow 260 towards the distal end 228 of the nozzle 220 and the shield cup outlet 254. The shield gas flow 260 exits the shield cup outlet 254 at the inward angle defined by the exit angle θ2 defined by the outer surface 229 and, thus, converges radially inward toward focal point 262. Consequently, the shield gas flow 260 may constrain and/or focus the plasma arc 264′ discharged from the nozzle orifice 226 to the focal point 262.

Notably, in the depicted embodiment, neither concave surface 229 nor concave surface 256 defines a corner and, thus, both surfaces 229 and 256 encourage smooth, laminar flow as the gas flow moves radially inwards. However, in other embodiments, concave surface 229 and/or concave surface 256 might define a corner or sharp edge while still guiding the shield gas flow 260 radially inwards into a convergent flow that constrains and/or focuses the plasma arc 264′ discharged from the nozzle orifice 226 to the focal point 262. That is, the slope of the inlet inner surface 256 and the slope of distal end outer surface 229 may be set at any slope, or angle, that facilitates a laminar flow having a high-speed boundary layer of shield gas 260 and/or that causes shield flow to converge on and constrict the plasma arc 264′ at a focal point 262 having a desired focal length Lf.

The dimensions of the distal portion 227 of the nozzle 220 and/or the dimensions of the shield cup 250 may dictate, or at least contribute to, a focal length Lf or distance between the frustoconical distal end 228 of the nozzle 220 and the focal point 262. Thus, the parabolic slopes of the inner surface 256 of the shield cup inlet 252 and the outer surface 229 of the nozzle's 200 distal portion 227 may be selected to set the focal length Lf at a desired distance. For example, the parabolic slope of the frustoconical distal end 228 outer surface 229 may be increased causing the focal length Lf to increase. As a specific example, the outer surface 229 may abruptly transition from a substantially horizontal slope (e.g., perpendicular to the longitudinal axis 201) to a steep exit angle θ2 (e.g., 30 degrees or less with respect to the longitudinal axis 201). Alternatively, the parabolic slope of the distal end outer surface 229 of the nozzle 220 and/or the inlet inner surface 256 of the shield cup 250 may be decreased to decrease the focal length Lf of the focal point 262 of the shield gas 260. For example, the outer surface 229 may transition from a substantially horizontal entry angle θ1 (e.g., perpendicular to the longitudinal axis 201) to a larger exit angle θ2, such as 30 to 60 degrees with respect to the longitudinal axis 201). In fact, in at least some embodiments, exit angle θ2 may drive or dictate the focal length Lf.

Additionally, or alternatively, in some embodiments, the parabolic slope of the inlet inner surface 256 of the shield cup 250 may be altered to alter the focal length Lf. Decreasing the exit angle θ4 with respect to axis 201 (e.g., moving more vertical, towards 0 degrees) may allow more of the shield gas 260 to flow through the radial gap 258 without contacting surface 229 and, thus, may widen the annular cross-section of shield gas 260 exiting the shield cup outlet 254. In turn, the wider annular cross-section of shield gas may focus on a focal point (if measured at a center of the width of the annular cross-section) that is further away from the nozzle 220, extending the focal length Lf. By comparison, increasing the exit angle θ4 with respect to axis 201 (e.g., towards 90 degrees) may encourage more of the shield gas 260 to flow onto and along outer surface 229, which may cause the gas flow to exit the shield cup outlet 254 in a tight annular cross-section that reduces the focal length Lf, at least as compared to wider annular cross-section of shield gas 260.

As a specific example, if the inlet inner surface 256 abruptly transitions from entry angle θ3 (e.g., 30 degrees with respect to the longitudinal axis 201) to a nearly horizontal exit angle θ4 (e.g., perpendicular to the longitudinal axis 201), this may reduce the focal length Lf as compared to smaller exit angles θ4. Alternatively, if the parabolic slope of the inlet inner surface 256 of the shield cup 250 is reduced, this may reduce the exit angle θ4 and increase the focal length Lf. As a specific example, if the inlet inner surface 256 transitions from an angled slope (e.g., 30 degrees with respect to the longitudinal axis 201) to an exit angles θ4 in the range of 70 degrees to 90 degrees with to the longitudinal axis 201, this may decrease the focal length Lf as compared to a perpendicular exit angles θ4.

Still further, in some embodiments, the final diameter D1 of the distal end 228 of the nozzle 220 and/or the outlet diameter D2 of the shield cup 250 may impact the focal length Lf of the focal point 262. For example, increasing the final diameter D1 and/or the outlet diameter D2 may increase the focal length Lf of the focal point 262. Likewise, decreasing the final diameter D1 and/or the outlet diameter D2 may decrease the focal length Lf of the focal point 262. That is, the distance between the distal end 228 of the nozzle 220 and the focal point 262 of the plasma arc 264′ may be based on the final diameter D1 of the distal end 228 of the nozzle 220 and/or the outlet diameter D2 of the shield cup 250.

First, trigonometric principles dictate that, if the exit angle θ2 is held constant, increasing the final diameter D1 of the distal end 228 will increase the focal length Lf (and vice versa). Alternatively, changing the final diameter D1 of the distal end 228 of the nozzle 220 may change the slope of the distal end outer surface 229 and, thus, an angle at which the shield gas 260 is discharged from the nozzle 220. Still further, final diameter D1 of the distal end 228 of the nozzle 220 and/or the outlet diameter D2 of the shield cup outlet 254 may impact the speed at which the shield gas 260 exits the outlet 254, which may impact the ability of the shield gas 260 to constrain the plasma arc 264′ at the focal point 262. For example, a smaller outlet diameter D2 of the shield cup outlet 254 may increase a speed of a flow of the shield gas 260, while a larger outlet diameter D2 may decrease the speed of the flow of the shield gas 260. Additionally, if D2 is held constant, and the final diameter D1 is increased, an annular cross-section of the outlet 254 may be decreased which may increase a speed of a flow of the shield gas 260, while a smaller final diameter D1 may increase the annular cross-section of the outlet 254 and decrease the speed of the flow of shield gas 260.

The speed of the flow of shield gas 260 may impact the focal length Lf of the focal point 262 of the plasma arc 264′. That is, slower flow speeds of shield gas 260 may generate a shorter focal length Lf for the focal point 262 of the plasma arc 264′. Higher flow speeds of shield gas 260 may have a longer focal length Lf for the focal point 262 of the plasma arc 264′. However, the final diameter D1 of the distal end 228 of the nozzle 220 and the outlet diameter D2 of the shield cup outlet 254 may be any diameter, or length, that facilitates a laminar flow of shield gas to converge and constrict the plasma arc 264′ at a focal point 262 having a desired focal length Lf. Moreover, the speed of the flow of shield gas 260 may dictate a width of plasma arc 264′ at the focal point 262. For example, slower flow speeds of shield gas 260 may constrain a wider plasma arc 264′ at the focal point 262, while faster flow speeds of shield gas 260 may constrain a narrower plasma arc 264′ at the focal point 262.

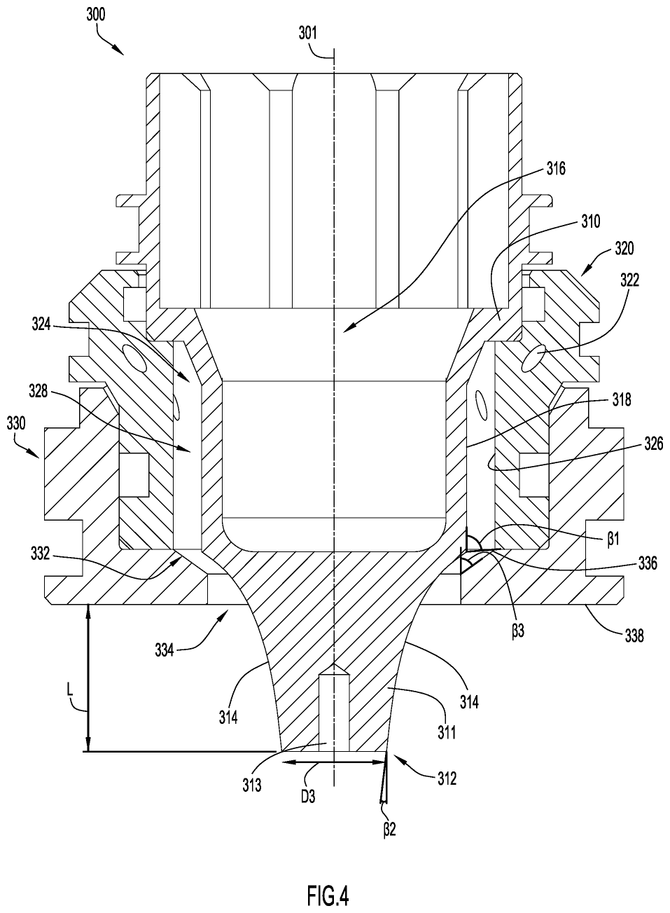

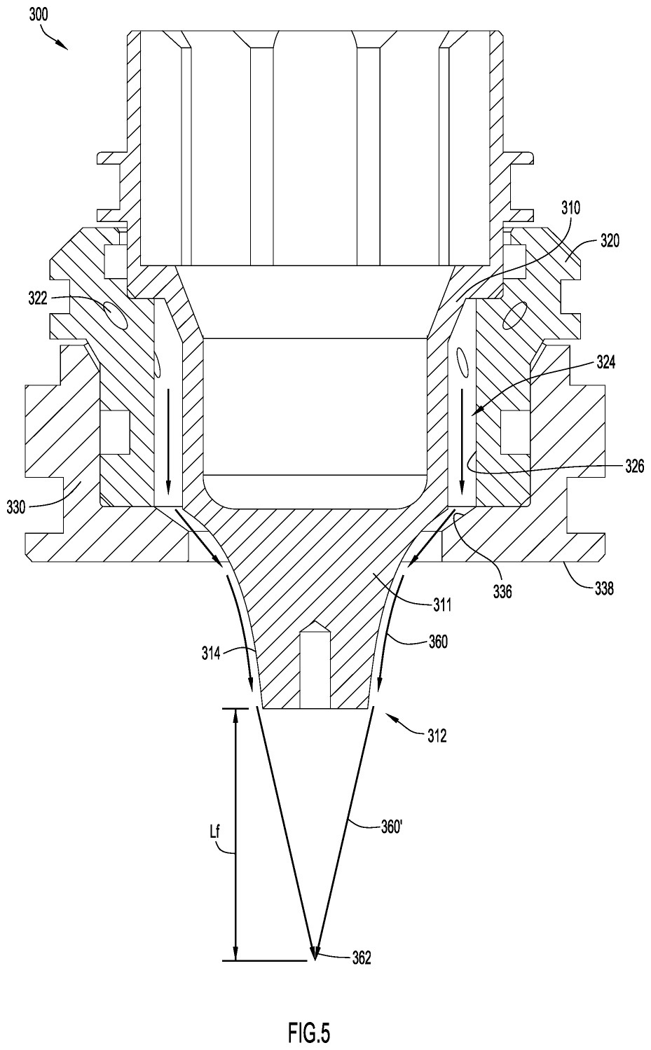

Now referring to FIGS. 4 and 5, a torch head 300 according to another embodiment of the present application is illustrated. The torch head 300 may be disposed in torch assembly 170; however, embodiments are not limited thereto. The torch head 300 includes an electrode 310, a distributor 320, and a shield cap 330 disposed along a longitudinal axis 301 of the torch head 300. However, to be clear, the term “shield cap” does not mean or imply that part 330 is conductive or non-conductive or has any other properties that might be associated with conventional shield cups. Instead, item 330 is referred to as a shield cap 330 because it is positioned on the exterior of the depicted consumable stack, where a conventional shield cap might be, but may be conductive in some embodiments and may be non-conductive in other embodiments. In fact, in some implementations, the torch head 300 may include additional shield cap or cup (not shown) disposed exteriorly of and concentric with and/or coupled to the shield cap 330.

That said, the electrode 310, the distributor 320, and the shield cap 330 are coaxial and/or concentric. The electrode 310 is disposed in a distributor cavity 324 defined by an inner surface 326. The distributor 320 is disposed between the electrode 310 and the shield cap 330 and the shield cap 330 is disposed around a portion of the distributor 320. Notably, the torch head 300 does not include a nozzle or tip; the reasons for which are described in detail below. However, in other embodiments, the torch head 300 could include a nozzle/tip or any other consumable or non-consumable components that might be required or helpful for plasma cutting or welding operations.

The electrode 310 includes an operative end or distal portion 311 terminating at a distal end 312 and a cavity 316 for receiving a cooling fluid. However, in some implementations, the electrode may not include a cavity 316. The distal portion 311 includes an emissive insert 313 and an outer surface 314. The distal portion 311 of the electrode 310 has a concave, frustoconical shape defined by the outer surface 314. That is, the distal portion outer surface 314 may have a parabolic slope, or shape. Put another way, a diameter, and/or a radius, of the electrode distal portion 311 decreases to a final diameter D3 at the distal end 312. In some implementations, the decrease in the radius may be exponential (i.e., the radius/diameter decays exponentially to the final diameter D3).

As a more specific example, in the depicted embodiment, the outer surface 314 of the electrode distal portion 311 may have an initial angle β1 of about 80 degrees with respect to the longitudinal axis 301 and transitions to an ending angle β2 of about 15 degrees with respect to the longitudinal axis 301. However, these angles are only examples and angle β1 and angle β2 may vary across different embodiments. For example, angle β1 may be any angle within a range of approximately 90 degrees and approximately 60 degrees with respect to the longitudinal axis 301, a range of approximately 85 degrees and approximately 70 degrees with respect to the longitudinal axis 301, or any other suitable range, for example, to create a smooth transition between gas passageway leading to the outer surface 314. Meanwhile the ending angle β2 may be any angle within a range of approximately 5 degrees and approximately 30 degrees with respect to the longitudinal axis 301, a range of approximately 0 degrees and approximately 45 degrees with respect to the longitudinal axis 301 or any other suitable range that allows control the focal point of a gas exiting the outer surface 314, as is described in detail below.

In the depicted embodiment, the distal portion 311 extends through the distributor cavity 324 of the distributor 320, an inlet 332 of the shield cap 330, and an outlet 334 of the shield cap 330. Thus, the distal end 312 of the electrode 310 protrudes a distance or length L past a distal end 338 of the shield cap 330 in a direction parallel to the longitudinal axis 301. However, in other embodiments, the electrode need not extend a distance L beyond the distal end 338 of the shield cap 330 and could be disposed or contained therein.

The distributor 320 surrounds a portion of the electrode 310 and includes a plurality of gas or fluid channels 322 for guiding a flow of process gas 360 into the distributor cavity 324. When the electrode 310 is disposed in the distributor cavity 324, an electrode outer surface 318 and the distributor inner surface 326 define an annular or radial gap 328. That is, the radial gap 328 extends radially between the electrode outer surface 318 and the distributor inner surface 326. The radial gap 328 is configured to guide a flow of process gas 360 to an inlet 332 of the shield cap 330. The inlet 332 may be angled to conform to a slope of the outer surface 314 of the electrode distal portion 311. That is, an inlet surface 336 of the inlet 332 may be angled to be parallel to the outer surface 314 of the electrode distal portion 311. In some implementations, the inlet 332 may be angled to be askew with respect to the slope of the outer surface 314 of the distal portion 311 of the electrode 310. That is, the inlet 332 may have a larger or smaller slope than the slope of the distal portion 311 outer surface 314.

During operation, a flow of the process gas 360 may be directed through the fluid channels 322 of the distributor 320 through the radial gap 328 to the shield cap inlet 332. The inlet surface 336 of the shield cap 330 may guide the flow of process gas 360 towards the electrode outer surface 314, which may cooperate with the inlet surface 336 to guide the flow of process gas 360 to the outlet 334 of the shield cap 330. After exiting the outlet 334 of the shield cup 330, the process gas 360 flows along the outer surface 314 of the distal portion 311, and converges at a focal point 362 downstream of the distal end 312 of the electrode 310. That is, the parabolic slope of the outer surface 314 of the distal portion 311 of the electrode 310 directs the flow of process gas 360 to converge at the focal point 362 at a focal length Lf downstream of the electrode distal end 312. In at least some implementations, the flow of process gas 360 is a laminar flow having a high-speed boundary layer. That is, the distal portion 311 and shield cap 330 cooperate such that the process gas flow 360 is a laminar flow having a high-pressure boundary layer.

An arc discharged from the distal end 312 of the distal portion 311 (e.g., from emissive insert 313) may be constrained or focused by the converging flow of process gas 360 at the focal point 362. The arc may generate a plasma arc 360′ from the process gas 360. That is, a portion or all of the flow of process gas 360 may be converted into a plasma and the convergent flow of process gas 360 may focus the plasma on focal point 362. In some embodiments, the plasma arc 360′ may be generated from a pilot arc generated between the electrode 310 and the shield cap 330 (provided the shield cap 330 is conductive). Specifically, the pilot arc may be generated between the outer surface 314 of the distal portion 311 and the inlet surface 336 of the shield cap 330. However, in other embodiments, the shield cap 330 may be non-conductive, ungrounded, and/or not connected to electricity and an arc may be struck in a different manner, such as via contact starting that strikes an arc between the electrode 310 and a workpiece.

The focal length Lf is the distance between the frustoconical distal portion 311 of the electrode 310 and the focal point 362, and may be any desired length based on the dimensions of the frustoconical distal portion 311 and/or shield cap 330. For example, the parabolic slope of the outer surface 314 of the distal portion 311 and a slope of the inlet surface 336 of the shield cap 330 may be selected to set the focal length Lf at a desired distance. In particular, if the exit angle β2 of the parabolic slope of outer surface 314 of the frustoconical distal portion 311 decreases, the focal length Lf may increase. As a specific example, if the outer surface 314 abruptly transitions from a substantially horizontal slope β1 (e.g., about 80 or about 90 degrees with respect to the longitudinal axis 301) to a steep exit slope β2 (e.g., about 15 degrees or less with respect to the longitudinal axis 301), the focal length may be increased as compared to an electrode with a shallower outer surface 314 (e.g., an exit angle β2 greater than 15 degrees). Likewise, if the exit angle β2 of the parabolic slope of outer surface 314 increases, such as from 10 degrees to approximately 30 degrees, the increase will cause the focal length Lf to decrease.

Additionally, or alternatively, in some embodiments, the slope β3 of the inlet surface 336 of the shield cap inlet 332 may be altered to alter the focal length Lf of the convergent flow of the process gas 360. Decreasing the angle β3 (e.g., moving more vertical, towards 0 degrees) may allow more shield gas 360 to flow through the radial gap 328 without contacting surface 314 and, thus, may widen the annular cross-section of the process gas 360 exiting the shield cap outlet 334. In turn, the wider annular cross-section of process gas 360 may focus on a focal point (if measured at a center of the width of the annular cross-section) that is further away from the electrode 310, extending the focal length Lf By comparison, increasing the angle β3 with respect to axis 301 (e.g., towards 90 degrees) may encourage more of the process gas 360 to flow onto and along outer surface 314 of the electrode 310, which may cause the gas flow to exit the shield cap outlet 334 in a tight annular cross-section that reduces the focal length Lf, at least as compared to wider annular cross-section the process gas 360.

As a specific example, in the depicted embodiment, the inner surface 336 of the shield cap 330 may have an angle β3 of about 45 degrees with respect to the longitudinal axis. However, this angle is only an example and angle β3 may vary across different embodiments. For example, angle β3 may be any angle within a range of approximately 30 degrees and approximately 70 degrees with respect to the longitudinal axis 301, a range of approximately 40 degrees and approximately 60 degrees with respect to the longitudinal axis 301, or any other suitable range, for example, to create a smooth transition from the radial gap 328 to the outlet 334. However, the inlet surface 336 of the shield cap inlet 332 may have any angle β3 that facilitates a laminar flow of process gas 360 that converges and constricts the plasma arc 360′ at a focal point 362 at a desired focal length Lf.

Additionally, or alternatively, the final diameter D3 of the distal end 312 of the distal portion 311 and/or the length L that the distal end 312 of the distal portion 311 protrudes from the distal end 338 of the shield cap 330 can impact the focal length Lf That is, the distance between the distal end 312 of the distal portion 311 and the focal point 362 of the plasma arc 360′ may be based on the final diameter D3 of distal end 312 of the distal portion 311 and/or the protrusion length L of the distal portion 311 beyond the distal end 338 of the shield cap 330. For example, increasing the final diameter D3 or the protrusion length L may increase the focal length Lf of the focal point 362. Meanwhile, decreasing the final diameter D3 or the protrusion length L may decrease the focal length Lf of the focal point 362.

In some instances, altering the dimensions of the final diameter D3 and the protrusion length L may alter the focal length Lf because alterations of diameter D3 and protrusion length L may impact the slope of the distal portion 311 outer surface 314 and, thus, an angle at which the process gas 360 leaves outer surface 314 of the electrode distal portion 311. Additionally or alternatively, altering the dimensions of the final diameter D3 and the protrusion length L may change the speed and/or velocity of the process gas 360, which may change the focal length Lf or a width of a plasma arc 360′ at the focal point 362. However, in different embodiments, the final diameter D3 and protrusion length L may be any diameter or length that facilitates a convergent flow of process gas 360 that converges on and constricts the plasma arc 360′ towards a focal point 362 having any desired focal length Lf.

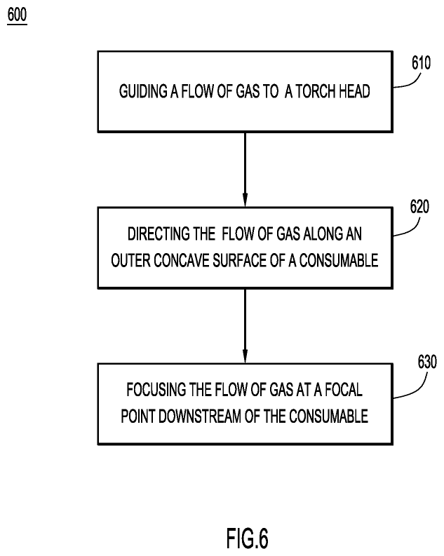

Now referring to FIG. 6, a method 600 of directing a flow of fluid (e.g., process gas or shield gas) through a torch according to an embodiment is shown. The method 600 includes guiding a flow of gas to a torch head at operation 610, directing the flow of gas along an outer concave surface of a consumable at operation 610, and focusing the flow of gas at a focal point downstream of the consumable at operation 630. The method may be carried out by the torch head assemblies 200 and 300 of FIGS. 2-5.

For example, at operation 610 the flow of gas may be supplied to a torch assembly via a cable hose (e.g., cable hose 172 of FIG. 1). The flow of gas may flow through a distributor (e.g., distributor 240, 320). At operation 620, the flow of gas may be directed along an outer concave surface of a consumable (e.g. nozzle 220, shield cup 250, electrode 310, shield cap 330), insofar as “outer” is used in operation 620 to describe a radially exterior surface and is not intended to denote any exterior surface of a consumable. At operation 630, the directed flow may be discharged downstream of the consumable to converge at a focal point. The converged flow focuses a plasma arc at the focal point downstream of the consumable. Thus, a plasma arc emanating from an electrode (e.g., electrode 210, 310) and/or a stream of plasma is constrained by the converging flow of gas.

The embodiments presented herein focus plasma arcs 264′, 360′ at focal points 262, 362, respectively, which may provide better cutting performance while generating less heat as compared to conventional torches. That is, a more focused arc provides a better cut performance, and thus, requires less power to accomplish the same result as compared to a conventional consumable. Additionally, the heat from the focused plasma arcs 264′, 360′ may be dissipated by the focal length Lf of the focal point 262, 362, thus reducing the amount of heat absorbed by components of the torch head 200, 300. Therefore, the electrode 210, 310 may remain active for longer periods of time (e.g., higher duty cycles) without being damaged due to excess temperatures and/or have a longer lifespan. That is, the electrode 210, 310 may maintain a plasma arc 264′, 360′ having better cutting performance for a longer period of time before shutting down to cool as compared to conventional torches and/or provide more total cutting time as compared to electrodes included in conventional torches. Because the electrode 210, 310 may have a better cutting performance with a longer duty cycle than conventional torches, plasma operations may be more efficient and arc initiation sequences (which consume the nozzle 220 and/or shield cap 330) may be reduced as compared to conventional consumables. Thus, wear of the nozzle 220, or shield cap 330, also may be reduced as compared to conventional consumables. Additionally, due to the reduced heating from the focused plasma arc 264′, 360′, the amount of cooling supplied to the torch head 200, 300 may be reduced as compared to conventional consumables.

While the invention has been illustrated and described in detail and with reference to specific embodiments thereof, it is nevertheless not intended to be limited to the details shown, since it will be apparent that various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

It is also to be understood that the torch head described herein, or portions thereof may be fabricated from any suitable material or combination of materials, such as plastic, foamed plastic, metal, supple natural or synthetic materials including, but not limited to, cotton, elastomers, polyester, plastic, rubber, derivatives thereof, and combinations thereof. Suitable plastics may include high-density polyethylene (HDPE), low-density polyethylene (LDPE), polystyrene, acrylonitrile butadiene styrene (ABS), polycarbonate, polyethylene terephthalate (PET), polypropylene, ethylene-vinyl acetate (EVA), or the like. Suitable foamed plastics may include expanded or extruded polystyrene, expanded or extruded polypropylene, EVA foam, derivatives thereof, and combinations thereof.

Finally, it is intended that the present invention cover the modifications and variations of this invention that come within the scope of the appended claims and their equivalents. For example, it is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the invention.

Similarly, when used herein, the term “comprises” and its derivations (such as “comprising”, etc.) should not be understood in an excluding sense, that is, these terms should not be interpreted as excluding the possibility that what is described and defined may include further elements, steps, etc. Meanwhile, when used herein, the term “approximately” and terms of its family (such as “approximate”, etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially”.

What is claimed is:

1. A torch comprising:
a gas channel; and
a consumable having a frustoconical distal portion, the frustoconical distal portion having a concave outer surface configured to guide a flow of gas from the gas channel to a focal point downstream of frustoconical distal portion.

2. The torch of claim 1, wherein the consumable is a nozzle.

3. The torch of claim 2, further comprising an electrode disposed within a cavity of the nozzle.

4. The torch of claim 1, wherein the consumable is an electrode.

5. The torch of claim 4, further comprising a shield cap concentric with the electrode.

6. The torch of claim 5, wherein a distal end of the frustoconical distal portion extends beyond a distal end of the shield cap.

7. A method comprising:
guiding a flow of gas to a torch head; and
directing the flow of gas along an outer concave surface formed on a distal portion of a consumable, wherein the outer concave surface directs the flow of gas to a focal point downstream of a distal end of the consumable.

8. The method of claim 7, further comprising:
constraining a plasma arc at the focal point via the flow of gas.

9. The method of claim 8, wherein the consumable is a nozzle.

10. The method of claim 9, wherein the flow of gas is a flow of shield gas.

11. The method of claim 10, further comprising:
guiding the flow of shield gas through a radial gap between the nozzle and a shield cup; and
directing the flow of shield gas towards the outer concave surface of the nozzle with an inlet surface of the shield cup.

12. The method of claim 7, further comprising:
selecting a diameter of the consumable based on a desired focal length of the focal point.

13. The method of claim 7, further comprising:
selecting a parabolic slope of the concave outer surface of the consumable based on a desired focal length of the focal point.

14. The method of claim 8, wherein the consumable is an electrode.

15. The method of claim 14, wherein the flow of gas is a flow of process gas for generating plasma.

16. The method of claim 15, further comprising:
guiding the flow of process gas through a radial gap between the electrode and a shield cap; and
directing the flow of process gas towards the concave outer surface of the electrode with an inlet surface of the shield cap.

17. The method of claim 16, further comprising:
guiding the flow of process gas along the concave outer surface of the electrode past the shield cup.

18. A consumable for a torch head, comprising:
a frustoconical operative end; and
a concave outer surface formed on the frustoconical operative end and configured to guide a flow of gas to a focal point downstream of the frustoconical operative end.

19. The consumable of claim 18, wherein the consumable is an electrode or a nozzle.

20. The consumable of claim 18, wherein the concave outer surface is defined by a parabolic slope, the parabolic slope being selected based on a desired focal length of the focal point.
